(19) United States
(12) Patent Application Publication
(10) Pub. No.: US 2018/0189916 A1
(43) Pub. Date: Jul. 5, 2018

(54) ELECTRONIC MONETARY CLAIM SYSTEM AND METHOD FOR MANAGING PLEDGING OF MORTGAGE OF ELECTRONICALLY RECORDED MONETARY CLAIM WITH DEFENSE

(71) Applicant: Tranzax Co., Ltd., Tokyo (JP)

(72) Inventors: Takashi OGURA, Tokyo (JP); Ryoichi FUKAZAWA, Tokyo (JP)

(73) Assignee: Tranzax Co., Ltd., Tokyo (JP)

(21) Appl. No.: 15/909,354

(22) Filed: Mar. 1, 2018

Related U.S. Application Data
(63) Continuation of application No. PCT/JP2016/075022, filed on Aug. 26, 2016.

(30) Foreign Application Priority Data
Sep. 1, 2015 (JP) 2015-171834

(51) Int. Cl. G06Q 50/28; G06Q 40/02; G06Q 40/00

(52) U.S. Cl. CPC G06Q 50/28; G06Q 40/12; G06Q 40/025

(57) ABSTRACT

According to one form of the present disclosure, a system transmits a request for recording of generation of an electronic recorded monetary claim condition precedent with defense, to a ledger recorder. The system transmits an assignment recording request indicating that the electronic recorded monetary claim with defense has been pledged as an assignment guarantee, to the ledger recorder.

### CROSS-REFERENCE TO RELATED APPLICATIONS

This application is a continuation of International Application No. PCT/JP2016/075022, filed Aug. 26, 2016, which claims priority to and the benefit of Japanese Patent Application No. 2015-171834, filed Sep. 1, 2015. The disclosures of the above applications are incorporated herein by reference.

### FIELD

The present disclosure relates to an electronically recorded monetary claim system and method for managing pledging of mortgage of an electronically recorded monetary claim with defense (or subject to condition precedent), using a computer network.

### BACKGROUND

The statements in this section merely provide background information related to the present disclosure and may not constitute prior art.

Conventionally, a number of days have been spent from order to completion and delivery, in several industries like contractors such as a construction industry and a shipbuilding industry. Substantial resources are required in production processes in companies of such industries. In general, no payment is made until the delivery. Therefore, a burden of costs between order and delivery in order production of complex equipment, system development, time-consuming business from order to delivery such as construction, and the like, has been heavy for start up companies, and small and medium-sized enterprises, and, collateralization of a mortgage on a contract receivable with defense before delivery has been very difficult.

In recent years, an electronically recorded monetary claims act has been enacted and promulgated, and come into effect since December 2008. In relation to the electronically recorded monetary claims act, for example, a technology such as a method and system for management of borrower's bankruptcy using the electronically recorded monetary claim has been developed as disclosed in Patent Document 1 (JP5663626B). If a customer (borrower) is bankrupt, this technology can collectively retain existing electronically recorded monetary claims using a bank settlement account as a creditor account, and can also urge an electronically recorded monetary claim which has newly occurred to be automatically assigned and retains the monetary claim by registering bankruptcy information, and thereby reduces a burden of office procedure and post-management related to the retention.

In addition, as regards a discount of the above-explained electronically recorded monetary claim, a technology such as a system and method of automatically determining the possibility of execution of the discount of the electronically recorded monetary claim, based on creditworthiness of both a payment company “obligor” of the electronically recorded monetary claim and a discount requester have been developed as disclosed in Patent Document 2 (JP 5362867B). According this technology, the possibility of execution of the discount of the electronically recorded monetary claim is determined, based on the obligor's allowable maximum amount and the discount requester's discount maximum amount, and the possibility of execution of the discount of the electronically recorded monetary claim can be determined automatically and rapidly by considering creditworthiness of both the obligor and the discount requester.

PO is an abbreviation of “Purchase Order (Order)”. Loan at ordering point of time is a mechanism in which a financial institution and the like examines an order company, based on PO, and carry out financing for a subcontracting company having received PO from the order company. The loan at ordering point of time has a feature of being a scheme which extends credit to the subcontracting company, based on credit of the order company which is a PO publisher, on the assumption that borrower company has a technology and the ability to fulfill, and a feature of achieving a loan at ordering, i.e., a relatively early stage of a transaction.

As a basic scheme of the loan at ordering point of time, first, a subcontracting company (primary) receives order information from an order company and carries out an application of loan to a financial institution, based on the order information. The financial institution examines the subcontracting company (primary) which is the applicant and examines the order company which can be identified based on the order information. In the examination, it is determined whether the subcontracting company (primary) is equipped with the ability to fulfill an order content such as a technical capability, and the like. If the result of examination executed by the financial institution is successful, the loan to the subcontracting company is carried out. The subcontracting company (primary) can obtain working capital and can place an order to a subcontracting company (secondary). The subcontracting company (primary) pays a price of an inspected product or a part after delivery from the subcontracting company (secondary). The subcontracting company (primary) manufactures a finished product using the inspected product or the part and delivers the finished product to the order company. The order company pays a price of the finished product to the subcontracting company (primary), and the subcontracting company (primary) makes a repayment to the financial institution which has loaned, based on the price. Thus, money which has been loaned from the financial institution does not only facilitate the subcontracting company (primary) making payment to the further subcontracting company, but is appropriated for employment, payment of salaries and improves cash flow for business continuity for the company. In other words, PO exhibits effects of improving fluidity of funds in a supply chain and improving the cash flow of each company in the supply chain.

### SUMMARY

As explained above, a number of companies, for example, contractors of the construction industry, the shipbuilding industry, and the like spend a lot of days until the completion and delivery from the order. Substantial resources are required in the production processes in such companies. A Company having financial margin may not have a problem, but small and medium-sized enterprises, company having no financial margin, and company having no collateral of real estate, etc., may not be able to borrow money from a bank, or the like. In addition, obtaining debtor's consent to assignment of an obligation before inspection has been difficult. Recently, demands to make electronically recorded monetary claims occur and to borrow funds banks or the like by using electronically recorded monetary claims as assigned mortgage have been therefore increased.

However, Patent Document 1 aims to register the bankruptcy information, and Patent Document 2 aims only to automatically determine possibility of execution of the discount of the electronically recorded monetary claim, and a mechanism of financing for the subcontracting company receiving PO from the order company which is the PO publisher has not been effectively utilized for the above-explained electronically recorded monetary claim.

In addition, revision of a Small and Medium-sized Enterprise Credit Insurance Act has been established as a part of introduction of a new small and medium enterprise policy carried out by a Small and Medium Enterprises Agency, handling of the electronically recorded monetary claim in a guarantee system (current asset-backed loan guarantee) of a credit guarantee corporation has been approved and, in contrast, (1) overall: underdeveloped, of a monitoring system in the financial institution, (2) personal property: difficulty in evaluation of personal property collateral and a cost required for the evaluation, implementation and costs of continuous monitoring carried out by the financial institution, and instability of a right relationship of personal property collateral, (3) monetary claim: difficulty in termination in a case where a special agreement on assignment prohibition is attached to accounts receivable, and the like have been recognized as current problems in accounts receivable (ABL) promotion.

The present disclosure has been accomplished in consideration of the conventionally existing circumstances explained above, and aims to make the electronically recorded monetary claim occur by PO. That is, in the present disclosure, the electronically recorded monetary claim can be handled as a financial interest at the time of order and, furthermore, the electronically recorded monetary claim subject to condition precedent can be handled after the time of order, by making the electronically recorded monetary claim occur from the initial time of the order. Furthermore, the present disclosure aims to facilitate financial evaluation of collateral by developing a monitoring system in a financial institution, to facilitate updating of the electronically recorded monetary claim subject to condition precedent (including termination in a case where an special agreement on assignment prohibition is attached to the accounts receivable) by computer processing, and to improve cash flow of the electronically recorded monetary claim in the loan at ordering point of time, when the electronically recorded monetary claim subject to condition precedent are collateralized.

An electronic monetary claim system according to one form of the present disclosure is communicably connected to a first terminal used by an order company, a second terminal used by a delivery company, a third terminal used by a financial institution of the delivery company, and a ledger recorder recording electronic record ledger data in an electronic monetary claim recording institution. The electronic monetary claim system includes a first management unit and a second management unit. The first management unit transmits generated record request data of an electronically recorded monetary claim with defense to the ledger recorder, by an electronic contract function, when receiving a placing order registration of the electronically recorded monetary claim with defense from the first terminal and receiving a first approval registration of the placing order registration from the second terminal or when receiving a receiving order registration of the electronically recorded monetary claim with defense from the second terminal and receiving a second approval registration of the receiving order registration from the first terminal. The second management unit transmits assignment record request data including information indicating that the electronically recorded monetary claim with defense have been pledged as mortgage when an assignment request for pledging of the mortgage of the electronically recorded monetary claim with defense is transmitted from the second terminal to the third terminal, then an approval corresponding to the assignment request is transmitted from the third terminal to the second terminal and, furthermore, when receiving a mortgage registration for pledging of the mortgage of the electronically recorded monetary claim with defense from the second terminal.

According to the present disclosure, the electronically recorded monetary claim can be handled as a financial target at the ordering and, furthermore, the electronically recorded monetary claim subject to condition precedent can be handled at the time of ordering, by generating the electronically recorded monetary claim by PO, i.e., generating the electronically recorded monetary claim at the initial time of ordering.

In other words, in the prior art, since payment is not executed until the delivery, in general, cost burden from the ordering to the delivery has been heavy for start up companies and small and medium-sized enterprises, and collateralizing the mortgage on contract receivables with defense before delivery has been very difficult, as regards the business for which much time needs to be spent from the ordering to the delivery such as order production of complex equipment, system development, and construction. However, the above-explained difficulties can be overcome by use of the electronically recorded monetary claim. Since the electronically recorded monetary claim can be handled at the credit guarantee corporation by the revision of the Small and Medium-sized Enterprise Credit Insurance Act, evaluation of the electronically recorded monetary claim as collateral can be made excellent. According to a ministerial ordinance for partial revision of Enforcement Regulations for the Small and Medium-sized Enterprise Credit Insurance Act, the electronically recorded monetary claim to be handled are defined as “an electronically recorded monetary claim (limited to that which has been generated on the basis of an article or service providing or a contract to permit machinery or other article to be used)”, and the electronically recorded monetary claim generated at the time of the order is capable of being handled (Enforcement on Sep. 20, 2013). In addition, the mortgage on contract receivables (mortgage with defense) before completion and delivery can be secured in a current asset-backed loan guarantee system of a credit guarantee corporation.

Furthermore, according to the present disclosure, in the case of collateralizing the electronically recorded monetary claim subject to condition precedent, financial evaluation of the electronically recorded monetary claim as the collateral is facilitated and the electronically recorded monetary claim subject to condition precedent can easily be updated when the electronically recorded monetary claim subject to condition precedent are collateralized. For example, the electronically recorded monetary claim subject to condition precedent has a time limit (180 days), but the term can be extended by once formally liquidating and updating the electronically recorded monetary claims. Furthermore, according to the present disclosure, assignment can easily be carried out (the above-explained problem (3) can be solved) by activating ABL (accounts receivable) of electronically recorded monetary claims, i.e., by creating the electronically recorded monetary claim of the accounts receivable, and fundraising of the small and medium-sized enterprises can be facilitated.

Additional objects and advantages of the present disclosure will be set forth in the description which follows, and in part will be obvious from the description, or may be learned by practice of the present disclosure. The objects and advantages of the present disclosure may be realized and obtained by means of the instrumentalities and combinations particularly pointed out hereinafter.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a conceptual diagram showing an example of a monitoring service system according to a first form;

FIG. 2 is a conceptual diagram showing an example of an entire transaction flow of the monitoring service system according to the first form;

FIG. 3 is a conceptual diagram showing a schematic example of an electronic contract-order receiving function of the monitoring service system according to the first form;

FIG. 4 is a conceptual diagram showing a schematic example of accounts payable and receivable reconciliation function and a charging proxy function of the monitoring service system according to the first form;

FIG. 5 is a conceptual diagram showing a schematic example of an electronically recorded monetary claim request function of the monitoring service system according to the first form;

FIG. 6 is a conceptual diagram showing a schematic example of a collection registration function of the monitoring service system according to the first form;

FIG. 7 is a conceptual diagram showing a schematic example of a receiving agent function of the monitoring service system according to the first form;

FIG. 8 is a conceptual diagram showing a schematic example of a monitoring function of the monitoring the service system according to the first form;

FIG. 9 is a conceptual diagram showing a schematic example of an electronic document management service of the monitoring service system according to the first form;

FIG. 10 is a block diagram showing an example of a configuration of a computer system according to a second form; and

FIG. 11 is a sequence diagram showing an example of operations of the computer system according to the second form.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A cash flow improvement system and a cash flow improvement method using an electronically recorded monetary claim for a loan at ordering point of time, compatible with computer processing, according to the present disclosure, will be hereinafter described in detail with reference to the accompanying drawings.

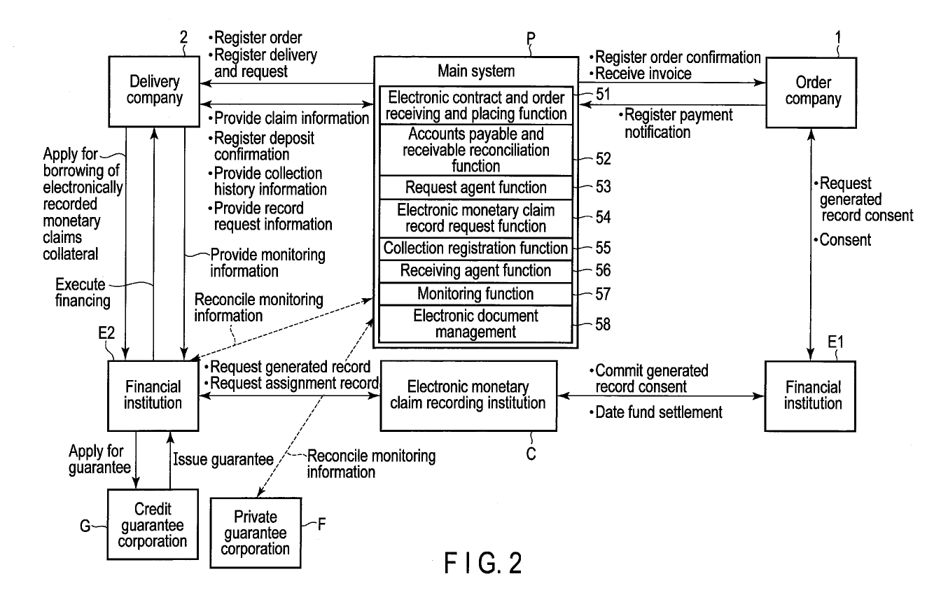

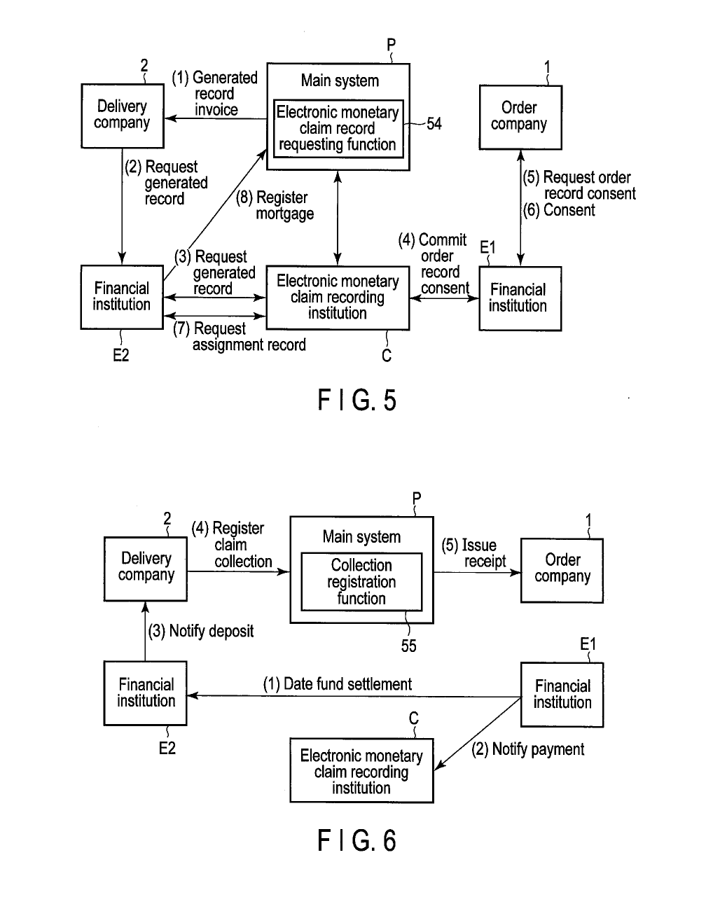

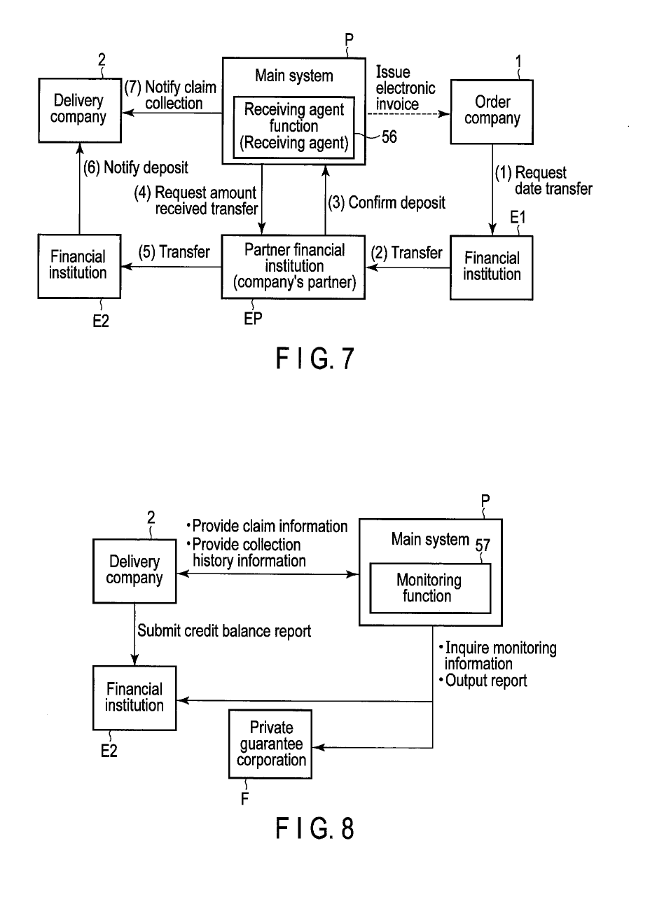

A requirement for efficacy of generation and assignment of the electronically recorded monetary claim is to execute electronically recording in a recording ledger of a system of an electronic monetary claim recording institution (electronic monetary claim (recording) services) (see FIG. 5). For example, if a terminal of an order company (payment company) 1 designates an amount of a claim, due date of payment, a creditor, and the like, of the electronically recorded monetary claim, and requests a system of an electronic monetary claim recording institution C to record generation, the system of the electronic monetary claim recording institution C records the generation of the electronically recorded monetary claim in the recording ledger. The electronically recorded monetary claim handling the ordering company 1 as the debtor thereby occurs. When the due date of payment of the electronically recorded monetary claim arrives, the amount of a claim is automatically withdrawn from an account of the order company 1 and automatically transferred to an account of a delivery company (order company) 2 which is the creditor (see FIG. 7). When the transfer is executed, the system of the electronic monetary claim recording institution C records a matter that the payment has been completed in the recording ledger as a payment record (see FIG. 2 and FIG. 6). In addition, a terminal of the delivery company 2 can also assign the electronically recorded monetary claim by requesting an assignment record to the system of the electronic monetary claim recording institution C through a financial institution (for example, bank, etc.) and recording the assignment in the recording ledger. In addition, the delivery company 2 can apply for a request for borrowing handling the electronically recorded monetary claim as collateral, to the financial institution.

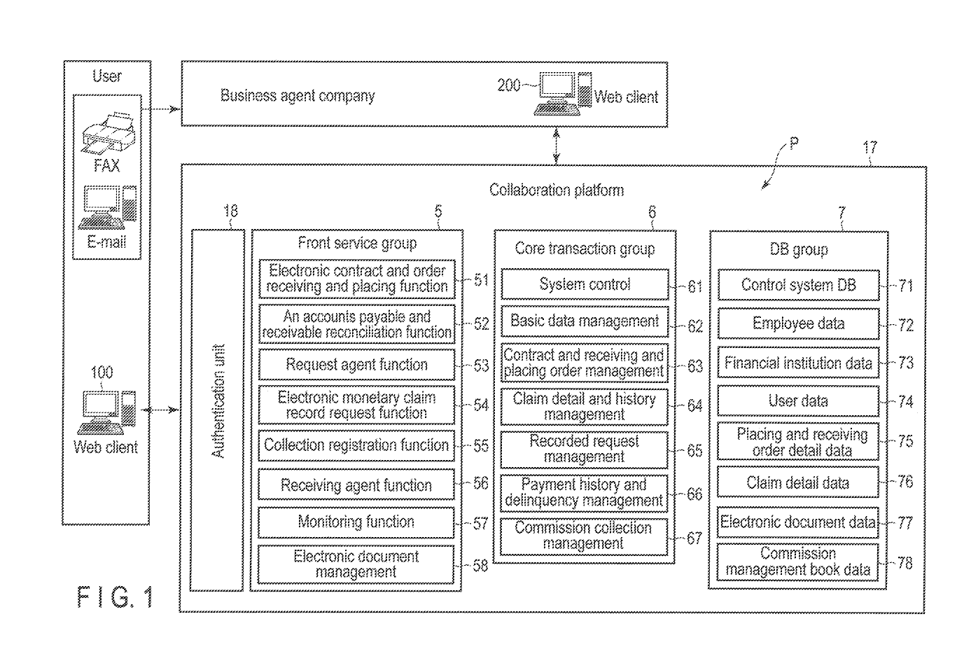

In the recent revision of the act, it is expected that the problem of ABL promotion concerning the claim can be solved by creating the electronically recorded monetary claim of the accounts receivable. In contrast, “underdevelopment of a monitoring organization and the like in the financial institution” which has been raised as the entire problem is considered remarkable in a local financial institution (financial institutions E1 and E2 explained later) having a number of small and medium-sized enterprise transactions. Accordingly, in one form of the present disclosure, the electronically recorded monetary claim is used by considering these local financial institutions E1 and E2 as targets, and a monitoring service system P (hereinafter referred to as the main system P) which is related to labor saving is constructed (see FIG. 1 and FIG. 2).

In a guarantee system of a credit guarantee corporation G shown in FIG. 2, an individual guarantee and a revolving guarantee are defined. The individual guarantee can be managed within the scope of an administrative procedure of a general electronically recorded monetary claim discount (collateral), for the financial institution E2 in cooperation with the delivery company 2, and importance for use of the main system P is small. In contrast, as regards the revolving guarantee, a credit guarantee corporation G adopts a system of determining a maximum guarantee amount based on scoring of a credit risk database (CRD) and not executing review for one year. Thus, since the utility value is high for small and medium-sized enterprises of the borrower side while the financial institution E2 in cooperation with the delivery company 2 needs to monitor transition of balance of an accounts receivable (electronically recorded monetary claim), the main system P has a high utility value. Accordingly, the main system P includes a mechanism to accumulate data from ordering contract stage and to provide information such as order balance transition, claim balance transition, and the like.

In addition, in the main system P, since a problem may occur in data accuracy if there is no convenience for small and medium-sized enterprises to use, a series of transaction from placing and receiving orders to settlement can be utilized on Web base, office rationalization is implemented and, for example, services such as an electronic contract, issuing an electronic invoice, document management, providing journal information, and the like are provided.

The electronic monetary claim recording institution C is provided with a system which enables an electronic claim (record) to be used on a network if a user side desires. Since the electronically recorded monetary claim subject to condition precedent (or the electronically recorded monetary claim with defense) can be handled and the guarantee institution of the credit guarantee corporation G is targeted to the accounts receivable of non-occurrence, in the electronic monetary claim recording institution C, user convenience is increased by using the electronic monetary claim recording institution C. Therefore, the main system P enables data exchange with the electronic monetary claim recording institution C.

The main system P includes not only a function of using the guarantee institution of the credit guarantee association G, but also a function corresponding to a use model of a private guarantee company F or a function of using a portfolio evaluation model.

FIG. 1 is a conceptual diagram of the main system leading to labor savings using the electronically recorded monetary claim of loan at ordering point of time according to one form of the present disclosure. In this form, the main system P is connected to (included in) a Web client 200 (hereinafter referred to as a monitoring service terminal 200) of a business agent company which monitors the transition of balance of the electronically recorded monetary claim in the financial institution E2 in cooperation with the delivery company 2, as a collaboration platform 17. In addition, a user's Web client 100 (hereinafter referred to as a user terminal 100) is a terminal of each of an order company 1, the delivery company 2, financial institutions EP, E1, and E2, a private guarantee company F (including a FAX and an E-mail), and the like, and is connected to the main system P, based on arbitrary authentication of an authentication unit 18 via an Internet, to transmit and receive various types of information.

The monitoring service terminal 200 is constructed separately in a front service group 5 for users, a core transaction group 6 for internal processing, and a database (DB) group 7. The front service group 5 includes a core function and an optional function. In addition, the core transaction group 6 is a basic internal processing function and starts simultaneously with a core function of the front service group 5. The front service group 5 includes an electronic contract and order receiving and placing function 51, an accounts payable and receivable reconciliation function 52, a request agent function 53, an electronic monetary claim record request function 54, a collection registration function 55, a receiving agent function 56, a monitoring function, an electronic document management 58, and the like. The core transaction group 6 includes various functions such as a system control 61, a basic data management 61, a contract and receiving and placing order management 63, a claim detail and history management 64, a recorded request management 65, a payment history and delinquency management 66, and a commission collection management 67. The database group 7 includes a control system database 71 and stores various types of data or information such as employee data 72, the financial institution data 73, user data 74, placing and receiving order detail data 75, claim detail data (history data) 76, electronic document data 77, and commission management book data 78.

FIG. 2 is a conceptual diagram showing an example of an overall transaction flow of the main system P according to one form of the present disclosure. As shown in FIG. 2, the main system P executes order registration and delivery and request registration for the terminal of the delivery company 2. In addition, providing the claim information, deposit confirmation and registration, providing collection history information, and providing record request information are executed between the main system P and the terminal of the delivery company 2. The terminal of the delivery company 2 executes applying the electronically recorded monetary claim and collateral loans, and providing monitoring information to the terminal of the financial institution E2 of the delivery company 2. Monitoring information inquiry is executed between the terminal of the financial institution E2 of the delivery company 2 and the main system P, and the financial institution E2 executes financing to the delivery company 2. The terminal of the financial institutions E2 of the delivery company 2 executes application of guarantee to the terminal of the credit guarantee corporation G, and the credit guarantee corporation G issues a guarantee to the terminal of the financial institution E2 of the delivery companies 2. The private guarantee company F can also be used instead of the credit guarantee corporation G. Assignment record request is executed between the terminal of the financial institution E2 of the delivery company 2 and the system of the electronic monetary claim recording institution C. The main system P executes order confirmation registration and invoice reception to the terminal of the order company 1. In response to this, the terminal of the order company 1 executes payment notification registration to the main system P. Occurring record consent request and its consent are executed between the terminal of the order company 1 and the terminal of the financial institution E1 of the order company 1. Generated record consent commission and date fund settlement are executed between the terminal of the financial institutions E1 of the order company 1 and the system of the electronic monetary claim recording institution C.

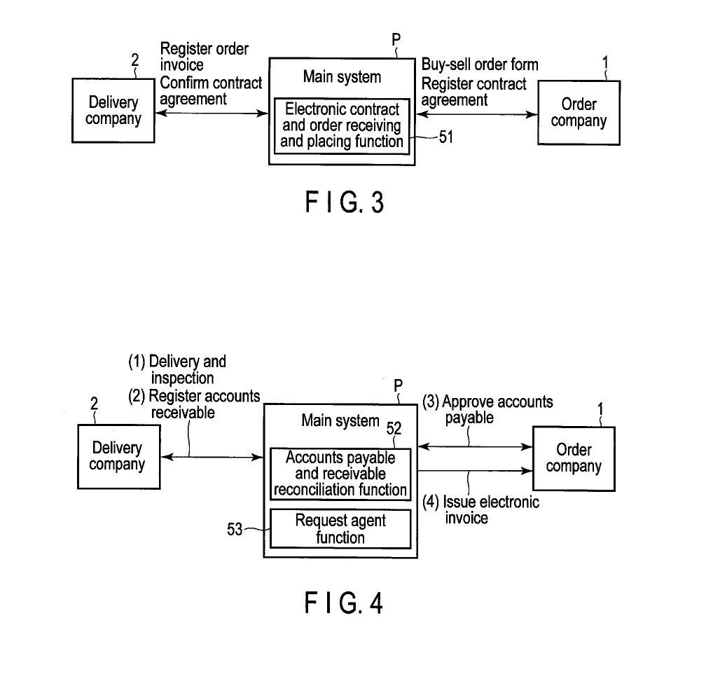

FIG. 3 is a conceptual diagram showing a schematic example of an electronic contract-ordering function 51 of the main system P according to one form of the present disclosure. The electronic contract and order receiving and placing function 51 of the front service group 5 completes delivery of a buy-sell order form and its acknowledgment in a document management system by electronic contract. In this case, a stamp duty is unnecessary, and an electronic certificate and a time stamp corresponding to national taxes are automatically assigned. In addition, placing order registration and receiving order registration are executed by any one of the terminal of the order company 1 and the terminal of the delivery company 2, by receiving and placing order registration, and a counterpart executes approval registration. More specifically, as shown in FIG. 3, order acknowledgment registration or contract agreement confirmation is executed between the main system P and the terminal of the delivery company 2, and registration of a buy-sell order form or contract agreement is executed between the main system P and the terminal of the ordering company 1.

FIG. 4 is a conceptual diagram showing a schematic example of the accounts payable and receivable reconciliation function 52 and the request agent function 53 of the main system P according to one form of the present disclosure. The accounts payable and receivable reconciliation function 52 registers accounts receivable details after receiving the completion of delivery inspection from the terminal of the delivery company 2. However, if the electronic contract and order receiving and placing function 51 is utilized, the accounts payable and receivable reconciliation function 52 automatically registers the accounts receivable details. The terminal of the order company 1 executes input of accounts payable approval after checking a registration content of the accounts receivable details. If the terminal of the delivery company 2 requests creating the electronically recorded monetary claim, the terminal of the ordering company 1 inputs debtor's consent. The electronic monetary claim record request function 54 is thereby executed automatically. In addition, the request agent function 53 issues an electronic invoice (PDF document) in a preliminarily registered invoice form to the order company 1, at an opportunity of debt approval input from the terminal of the order company 1. In this case, the electronic certificate and the time stamp are automatically assigned to an electronic invoice. The terminal of the order company 1 retrieves out and prints the electronic invoice. More specifically, as shown in FIG. 4, delivery/inspection and accounts receivable registration are executed between this main system P and the terminal of the delivery company 2, and the accounts payable approval is executed between the main system P and the terminal of the order company 1. In addition, the main system P issues the electronic invoice to the terminal of the order company 1.

FIG. 5 is a conceptual diagram showing a schematic example of an electronic monetary claim record requesting function 54 of the main system P according to one form of the present disclosure. The electronic monetary claim record request function 54 provides a function of generating a form or data necessary for the terminal of the delivery company 2 to make a request for the generated record request to the terminal of the financial institution E2 of the delivery company 2 and enabling the terminal of the delivery company 2 to transmit or upload the generated form or data to the terminal of the financial institution E2. As shown in FIG. 5, the system of the electronic monetary claim recording institution C notifies a consent request to the terminal of the financial institution E1 which is in cooperation with the order company 1, and records the electronically recorded monetary claim by consent of the terminal of the ordering company 1. The main system P automatically transmits the generated record request to a recording institution of the electronic monetary claim recording institution C. In addition, assignment record request for collateralization is executed between the delivery company 2 and the financial institution E2 and, in the main system P, the fact that a claim for a certain order company 1 has been pledged as mortgage is registered in claim details.

More specifically, as shown in FIG. 5, the main system P transmits a generated record invoice to the terminal of the delivery company 2. The terminal of the delivery company 2 executes the generated record request to the terminal of the financial institution E2. The generated record request is executed between the system of the electronic monetary claim recording institution C and the terminal of the financial institution E2 of the delivery company 2. A generated record consent commission is executed between the system of the electronic monetary claim recording institution C and the terminal of the financial institution E1 of the order company 1. A generated record consent request and its consent are executed between the terminal of the order company 1 and the terminal of the financial institution E1 of the order company 1. The assignment record request is executed between the system of the electronic monetary claim recording institution C and the terminal of the financial institution E2 of the delivery company 2. The terminal of the financial institution E2 of the delivery company 2 executes a mortgage registration in the main system P. Simultaneously with this, the generated record request is executed between the main system P and the system of the electronic monetary claim recording institution C, and the assignment record request is executed between the terminal of the financial institution E2 of the delivery company 2 and the system of the electronic monetary claim recording institution C.

FIG. 6 is a conceptual diagram showing a schematic example of a collection registration function 55 of the system P according to one form of the present disclosure. The collection registration function 55 registers debt collection after confirming a deposit of accounts receivable by the terminal of the delivery company 2. At this time, when the terminal of the ordering company 1 inputs issue of a receipt to the collection registration function 55 as needed, the collection registration function 55 transmits an electronic receipt addressed to the order company 1, to the terminal of the order company 1. More specifically, as shown in FIG. 6, the terminal of the financial institution E1 of the order company 1 executes a date fund settlement to the terminal of the financial institution E2 of the delivery company 2. The terminal of the financial institution E1 executes payment notification to the system of the electronic monetary claim recording institution C. The terminal of the financial institution E2 of the delivery company 2 notifies the terminal of the delivery company 2 of the deposit, and the terminal of the delivery company 2 executes debt collection registration to the system P. The main system P issues a receipt to the terminal of the order company 1.

FIG. 6 is a conceptual diagram showing a schematic example of a receiving agent function 56 of the system P according to one form of the present disclosure. The receiving agent function 56 may be used when the electronically recorded monetary claim is not used or the electronic monetary claim recording institution C may be used instead. If the main system P is employed, the delivery company 2 opens a dedicated account in a partner financial institution EP of the company's partner. The receiving agent function 56 designates the account as a transfer destination account in an invoice addressed to the order company 1. Therefore, if the receiving agent function 56 is employed, consent of the order company 1 is required in advance. The receiving agent function 56 of the main system P reconciles information of deposit to a dedicated account with request information and, if the reconciliation is successful, executes collection registration in the claim details and notifies the terminal of the delivery company 2 of a debt collection. The amount received is rapidly transferred into a bank account of the delivery company 2 after a commission is deducted. However, if the claim is a mortgage, the amount received can also be transferred into a lending financial institution account.

More specifically, as shown in FIG. 7, the receiving agent function 56 issues an electronic invoice to the terminal of the order company 1. Then, the terminal of the order company 1 makes a date transfer request to the terminal of the financial institution E1 of the order company 1. The terminal of the financial institution E1 of the order company 1 executes transfer to a dedicated account of the system of the partner financial institution EP of the company's partner. The system of the partner financial institution EP executes deposit confirmation in the system P, and the main system P makes an amount received transfer request to the system of the partner financial institution EP. The system of the partner financial institution EP executes transfer to the bank account of the financial institution E2 of the delivery company 2. Simultaneously with this, the terminal of the financial institution E2 of the delivery company 2 notifies the terminal of the delivery company 2 of a deposit. The main system P notifies the terminal of the delivery company 2 of the debt collection.

FIG. 8 is a conceptual diagram showing a schematic example of a monitoring function 57 of the main system P according to one form of the present disclosure. The monitoring function 57 provides the terminal of the delivery company 2 with information such as a debt collection situation, credit by debtors balance, and balance transition. In addition, if there is an agreement between parties, the monitoring function 57 executes inquiry of the same information and providing a report to the terminal of the lending financial institution E2 or the terminal of the private guarantee company F. More specifically, as shown in FIG. 8, providing credit information and providing collection history information are executed between with the monitoring function 57 of the main system P and the delivery company 2. The terminal of the delivery company 2 executes submitting a credit balance report to the terminal of the financial institution E2 of the delivery company 2. The monitoring function 57 of the main system P executes monitoring information inquiry and providing the report to the terminal of the financial institutions E2 of the delivery company 2 and the terminal of the private guarantee company F.

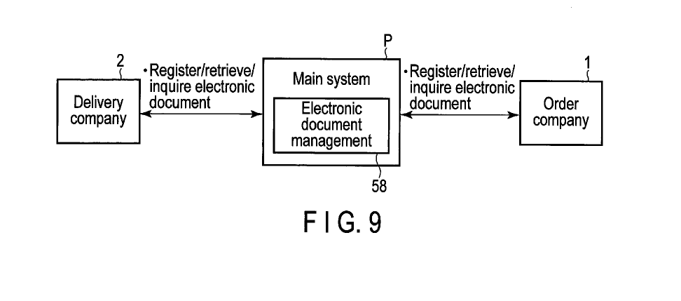

FIG. 9 is a conceptual diagram showing a schematic example of the electronic document management 58 of the main system P according to one form of the present disclosure. The electronic document management 58 provides an electronic document management system corresponding to national taxes as a standard function. The electronic document management 58 executes, for example, storage of an electronic certificate and a PDF document with a time stamp. The electronic document management 58 of the main system P can store contract documents, order documents, invoices, receipts, report documents, and the like to be used in folders etc., to folders for different users and store the documents for a long term of 10 years or more. Delivery of a document between users by the electronic document management 58 is executed by reference to the document in a user folder or downloading. If a user wishes, the electronic document management 58 can register the other transaction documents. More specifically, as shown in FIG. 9, the electronic document management 58 of the main system P executes electronic document registration, retrieval, and inquiry between the electronic document management 58 and the terminal of the delivery company 2, and between the electronic document management 58 and the order company 1.

The computer system according to one form is the cash flow improvement system using the electronically recorded monetary claim in loan at ordering point of time, wherein the main system P for monitoring the balance transition of the electronically recorded monetary claim in the financial institution in a case of collateralizing the electronically recorded monetary claim is connected in the Internet to the user terminals including the terminal of the order company 1, the terminal of the delivery company 2, the terminal of the financial institutions E2, and the terminal of the private guarantee company F. The main system P includes the front service group 5 for user including the functions such as the electronic contract and order receiving and placing function 51, the accounts payable and receivable reconciliation function 52, the request agent function 53, the electronic monetary claim record request function 54, the collection registration function 55, the receiving agent function 56, and the monitoring function 57, and the core transaction group 6 for inner processing including the functions such as the system control 61, the basic data management 62, the contract and receiving and placing order management 63, the claim detail and history management 64, the record request management 65, the payment history and delinquency management 66 and the commission collection management 67.

The computer system according to one form is the cash flow improvement system using the electronically recorded monetary claim in loan at ordering point of time, wherein the terminal of the order company 1, the terminal of the delivery company 2, the terminal of the financial institution E2, and the system of the electronic monetary claim recording institution C are connected in the Internet to the main system P. The computer system includes a record request management unit which executes a confirmation action of order receiving and placing contract between the terminal of the order company 1 and the delivery company 2, generates record request data, and transmits the record request data to the system of the electronic monetary claim recording institution C, and a record request management unit which executes a confirmation action concerning assignment of an obligation between the terminal of the delivery company 2 and the terminal of the financial institution E2, generates record request data, and transmits the record request data to the system of the electronic monetary claim recording institution C. The system of the electronic monetary claim recording institution C transmits recording result data based on the record request data by a message exchange function and executes notification of record completion to the terminal of the order company 1, the terminal of the delivery company 2, and the terminal of the financial institution E2.

A first method according to one form is a method of improving cash flow by the electronically recorded monetary claim in loan at ordering point of time, wherein the main system P for monitoring the balance transition of the electronically recorded monetary claim in the financial institution in a case of collateralizing the electronically recorded monetary claim is connected in the Internet to the user terminals including the terminal of the order company 1, the terminal of the delivery company 2, the terminal of the financial institutions E2, and the terminal of the private guarantee company F. In the first method, the main system P includes a step of storing data from a stage of an ordering contract made by the terminal of the order company 1 and the terminal of the delivery company 2, and a step of inquiring information of an order balance transition and a claim balance transition to the terminal of the financial institution E2 and the terminal of the private guarantee company F as monitoring information.

A second method according to one form is a method of improving cash flow by the electronically recorded monetary claim in loan at ordering point of time, using a computer system, wherein the terminal of the order company 1, the terminal of the delivery company 2, the terminal of the financial institution E2, and the system of the electronic monetary claim recording institution C are connected in the Internet to the main system P. The second method includes a step of performing delivery, inspection, invoicing, accounts payable and receivable reconciliation, and collection registration between the terminal of the delivery company 2 and the terminal of the order company 1, a step of making a request for recording termination of the condition precedent (disconnection of defense) to the system of the electronic monetary claim recording institution C, a step of generating record result data based on the recording request by the system of the electronic monetary claim recording institution C, a step of transmitting the record result data from the system of the electronic monetary claim recording institution C, and a step of executing notification of record completion to the terminal of the order company 1, the terminal of the delivery company 2 or the terminal of the financial institution E2 by the system of the electronic monetary claim recording institution C.

Second Form

In this second form, several parts of the first form will be explained in more detail. In the present first form will be denoted by the same reference numerals and their explanations will be omitted or the constituent elements will be explained simply.

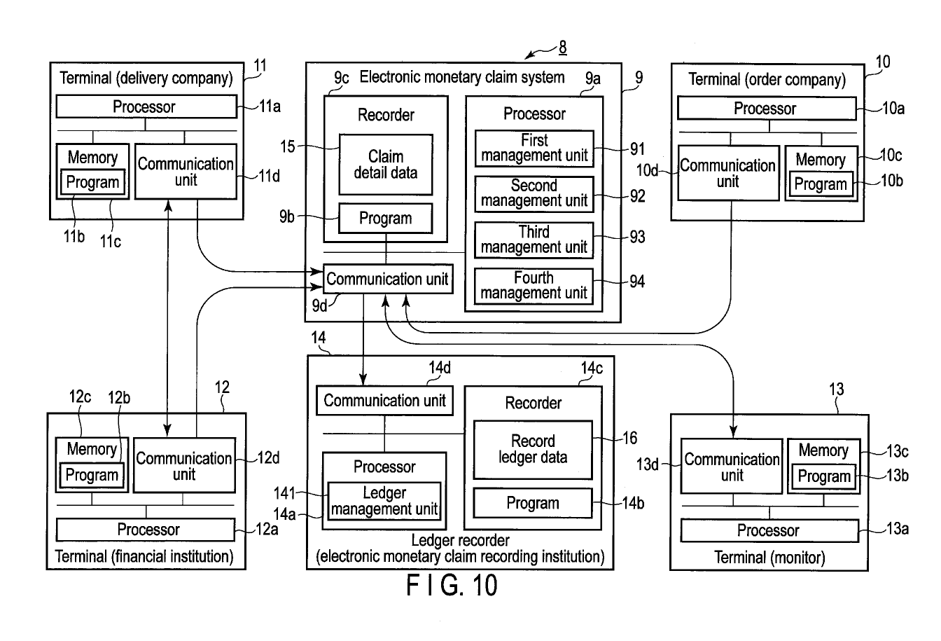

FIG. 10 is a block diagram showing an example of a configuration of a computer system according to the present form.

A computer system 8 includes an electronic monetary claim system 9, terminals 10 to 13, and a ledger recorder 14. It is assumed that in the computer system 8, the electronic monetary claim system 9, terminals 10 to 13, and a ledger recorder 14 can communicate with each other. For example, communications of data, signals, requests, commands, information, and the like are executed among the electronic monetary claim system 9, the terminals 10 to 13, and the ledger recorder 14.

The terminal 10 is used in the order company 1. The terminal 11 is used in the delivery company 2. The terminal 12 is used by the financial institution E2 in cooperation with the delivery company 2. The terminal 13 is used, for example, to monitor claim detail data 15 of the electronically recorded monetary claim. The ledger recorder 14 is managed by the electronic monetary claim recording institution C and records electronic recording ledger data 16. In the present form, the electronic monetary claim system 9 corresponds to the main system P of the first form. The terminals 10 to 12 correspond to the terminal of the order company 1, the terminal of the delivery company 2, and the terminal of the financial institution E2 in the first form, respectively. The ledger recorder 14 corresponds to the system of the electronic monetary claim recording institution C.

The terminal 10 is, for example, a computer and includes a processor 10a, a memory 10c which records a program 10b, and a communication unit 10d.

The processor 10a enables data communications with an external device data via the communication unit 10d by executing the program 10b recorded in the memory 10c. The program 10b may be, for example, an operating system and a browser.

A processor 11a provided in the terminal 11, a memory 11c recording a program 11b, a communication unit 11d, a processor 12a provided in the terminal 12, a memory 12c recording a program 12b, a communication unit 12d, a processor 13a provided in the terminal 13, a memory 13c recording a program 13b, and a communication unit 13d are similar to a processor 10a provided in the terminal 10, a memory 10c recording a program 10b, and a communication unit 10d, and their explanations are omitted.

The terminal 13 may be either the terminal 10 or 11. The terminal 13 may be, for example, the terminal 12 used in the financial institution E2, a terminal used by the other financial institution such as the financial institution E1 in cooperation with the order company 1, or the terminal used in the private guarantee company F.

The ledger recorder 14 is, for example, a database system and includes a processor 14a, a recorder 14c recording a program 14b and recording ledger data 16, and a communication unit 14d. The processor 14a enables data to be sent to or received from an external device via the communication unit 14d by executing the program 14b, and functions as a ledger management unit 141 which manages recording ledger data 16 (for example, registration, updating, reading, and the like).

The electronic monetary claim system 9 is, for example, a computer or database system, and includes a processor 9a, a recorder 9c recording a program 9b and claim detail data 15, and a communication unit 9d. The processor 9a enables data to be sent to or received from an external device via the communication unit 9d by executing the program 9b, and functions as first to fourth managers 91 to 94.

The first management unit 91 includes an electronic contract function, i.e., the electronic contract and ordering function 51 in the above-described first form. The first management unit 91 receives a placing order registration of electronically recorded monetary claim subject to condition precedent from the terminal 10 via the communication unit 9d and receives a first approval registration for the placing order registration from the terminal 11 via the communication unit 9d, by the electronic contract function. Alternatively, the first management unit 91 receives a receiving order registration of the electronically recorded monetary claim subject to condition precedent from the terminal 11 via the communication unit 9d and receives a second approval registration for the receiving order registration from the terminal 10 via the communication unit 9d. Then, the first management unit 91 transmits generated record request data of the electronically recorded monetary claim subject to condition precedent to the ledger recorder 14 via the communication unit 9d, when receiving the first approval registration or the second approval registration.

If an assignment request for pledging of mortgage of the electronically recorded monetary claim subject to condition precedent is sent from the terminal 11 to the terminal 12, if an approval corresponding to the assignment request is sent from the terminal 12 to the terminal 11, and if the second management unit 92 receives a mortgage registration from the terminal 12 via the communication unit 9d, the second management unit 92 transmits assignment record request data including information indicating that the electronically recorded monetary claim subject to condition precedent have been pledged as the mortgage, to the pledge recorder 14 via the communication unit 9d.

Furthermore, if the second management unit 92 receives cancellation of a condition precedent of the electronically recorded monetary claim subject to condition precedent from any one of the terminals 10 to 12 via the communication unit 9d, the second management unit 92 transmits change record request data including information indicating cancellation of the condition precedent of the electronically recorded monetary claim subject to condition precedent via the communication unit 9d.

If the third management unit 93 receives data relating to the electronically recorded monetary claim subject to condition precedent from the terminals 10 to 12 via the communication unit 9d, the third management unit 93 records claim detail data 15 in the recorder 9c or updates the claim detail data 15 recorded in the recorder 9c, based on the received data. The claim detail data 15 is, for example, data indicating a detail of the electronically recorded monetary claim subject to condition precedent. The claim detail data 15 may include, for example, history data including the first approval registration or second approval registration, the assignment request, and date and time of reception. The claim detail data 15 includes, for example, detailed status information (history data) of one or two or more electronically recorded monetary claims subject to condition precedent from an initial time of occurrence to the present time, for each delivery company 2. More specifically, the claim detail data 15 includes, for example, information generated at the present time for each electronically recorded monetary claim, of generation of a claim, change (for example, assignment, balance change, extension or reduction of a payment period, change of a loan, cancellation of the condition precedent), a product state (shipping, delivery, inspection), a debt collection (for example, payment receipt, extinguishment of a claim) and the like. For example, payment for the electronically recorded monetary claim subject to condition precedent is executed after termination of the inspection. The claim detail data 15 is different from the recording ledger data 16 and includes information more detailed than the recording ledger data 16.

For example, at the debt collection, the terminal of the financial institution E1 of the order company 1 executes a date fund settlement to the terminal 12 of the financial institution E2 of the delivery company 2, the terminal of the financial institution E1 transmits payment to the ledger recorder 14, the terminal 12 of the financial institution E2 of the delivery company 2 transmits a deposit notice to the terminal 11 of the delivery company 2, and the terminal 11 of the delivery company 2 executes a debt collection registration in the electronic monetary claim system 9. Then, the third management unit 93 updates the claim detail data 15 recorded in the storage unit 9c, based on the debt collection registration from the terminal 11.

In addition, if the third management unit 93 receives the cancellation of the condition precedent of the electronically recorded monetary claim subject to condition precedent from any one of the terminals 10 to 12 via the communication unit 9d, the third management unit 93 updates the claim detail data 15 recorded in the storage unit 9c, based on the cancellation of the condition precedent. The third management unit 93 may receive the cancellation of the condition precedent of the electronically recorded monetary claim subject to condition precedent, from the ledger recorder 14 via the communication section 9d.

The fourth management unit 94 receives a monitoring request from the terminal 13 which executes monitoring, via the communication unit 9d, and reads data included in the claim detail data 15 recorded in the recorder 9c, based on the received monitoring request. Then, the fourth management unit 94 transmits the read data to the terminal 13 via the communication unit 9d.

For example, the monitoring request may designate an arbitrary delivery company 2 of a plurality of delivery companies, and the claim detail data 15 may include history data of a plurality of electronically recorded monetary claims subject to condition precedent corresponding to the delivery company 2. In this case, the fourth management unit 94 transmits a plurality of elements of the history data corresponding to the delivery company 2 designated by the monitoring request, as data for determining an ability to fulfill an obligation of the delivery company 2, to the terminal 13 via the communication unit 9d.

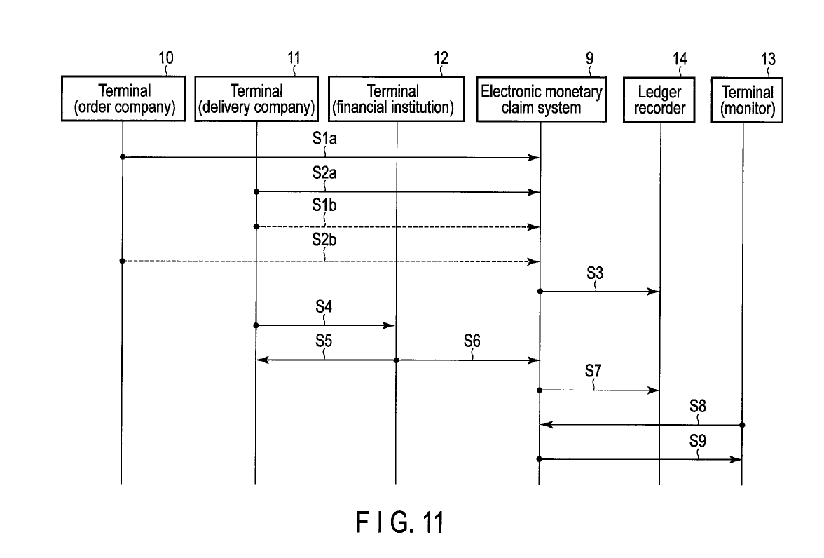

FIG. 11 is a sequence diagram showing an example of the operations of the computer system 8 according to one form of the present disclosure. In the explanations of FIG. 11, an explanation on execution of communications among the electronic monetary claim system 9, the terminals 10 to 13, and the ledger recorder 14 by using the communication units 9d to 14d will be omitted to simplify the explanations.

In step S1a, the terminal 10 transmits the order registration of the electronically recorded monetary claim subject to condition precedent to the electronic monetary claim system 9. The first management unit 91 of the electronic monetary claim system 9 receives the order registration from the terminal 10.

In step S2a, the terminal 11 transmits the first approval registration for the order registration to the electronic monetary claim system 9. The electronic monetary claim system 9 receives the first approval registration from the terminal 11.

Alternatively, in step S1b, the terminal 11 transmits the order registration of the electronically recorded monetary claim subject to condition precedent to the electronic monetary claim system 9. The first management unit 91 of the electronic monetary claim system 9 receives the order registration from the terminal 11.

In step S2b, the terminal 10 transmits the second approval registration for the order registration to the electronic monetary claim system 9. The first management unit 91 of the electronic monetary claim system 9 receives the second approval registration from the terminal 10.

Next, in step S3, the first management unit 91 of the electronic monetary claim system 9 transmits the generated record request data of the electronically recorded monetary claim subject to condition precedent to the ledger recorder 14. The ledger management unit 141 of the ledger recorder 14 records an occurrence of the electronically recorded monetary claim subject to condition precedent in the recording ledger data 16, based on the generated record request data. In addition, the third management unit 93 of the electronic monetary claim system 9 updates the claim detail data 15 recorded in the recorder 9c, based on the first approval registration or the second approval registration.

In step S4, the terminal 11 transmits the assignment request for pledging of the mortgage of the electronically recorded monetary claim subject to condition precedent to the terminal 12. The terminal 12 receives the assignment request from the terminal 12 the assignment request.

In step S5, the terminal 12 transmits the approval corresponding to the assignment request to the terminal 11. The terminal 11 receives the approval corresponding to the assignment request from the terminal 12.

Furthermore, in step S6, the terminal 12 transmits the mortgage registration to the electronic monetary claim system 9. The electronic monetary claim system 9 receives the mortgage registration from the terminal 12.

In step S7, the electronic monetary claim system 9 transmits the assignment record request data to the ledger recorder 14 when receiving the mortgage registration from the terminal 12. The ledger management unit 141 of the ledger recorder 14 updates the recording ledger data 16 recorded in the recorder 14c, based on the assignment record request data of the electronically recorded monetary claim subject to condition precedent received from the electronic monetary claim system 9. In addition, the third management unit 93 of the electronic monetary claim system 9 updates the claim detail data 15 recorded in the recorder 9c, based on the assignment record request data.

In step S8, the terminal 13 transmits the monitoring request to the electronic monetary claim system 9. The fourth management unit 94 of the electronic monetary claim system 9 reads the data included in the claim detail data 15 recorded in the recorder 9c, based on the monitoring request received from the terminal 13.

In step S9, the fourth management unit 94 of the electronic monetary claim system 9 transmits the read data to the terminal 13. The terminal 13 receives the data from the electronic monetary claim system 9 and displays the received data.

In the present form, the electronic monetary claim system 8 relays data transmission from the terminal 10 to the terminal 11, data transmission from the terminal 10 to the ledger recorder 14, data transmission from the terminal 11 to the terminal 10, data transmission from the terminal 11 to the ledger recorder 14, and data transmission from the terminal 12 to the ledger recorder 14. For this reason, the electronic monetary claim system 9 can record the claim detail data 15 including the state information (life cycle data) and the history data of the electronically recorded monetary claim, which are more detailed than the recording ledger data 16 recorded in the ledger recorder 14. Then, the terminal 13 can monitor the claim detail data 15 more detailed than the recording ledger data 16.

In the present form, the debt collection recorded in the ledger recorder 14 can be recorded in the claim detail data 15 of the electronic monetary claim system 9 and managed as a part of the history data of the electronically recorded monetary claim subject to condition precedent, on a payment due date.

In the present form, the history data from multiple orders corresponding to the designated delivery company 2 to the present time have been recorded as the claim detail data 15 and, since a plurality of elements of history data corresponding to the designated delivery company 2 can be monitored, determination of the ability to fulfill the obligation of the delivery company 2 can be supported.

In the present form, the cancellation of the condition precedent for the electronically recorded monetary claim subject to condition precedent can be recorded in the recording ledger data 16 of the ledger recorder 14 and can be recorded in the claim detail data 15 of the electronic monetary claim system 9.

In the present form, the electronic monetary claim system 8 relays the data transmission from the terminal 12 to the ledger recorder 14. As also explained in the first form, however, instead of this, the terminal 12 may transmit data to the ledger recorder 14, not via the electronic monetary claim system 8. In this case, however, the terminal 12 transmits report data indicating that the data transmission to the ledger recorder 14 has been executed, to the electronic monetary claim system 8, and the electronic monetary claim system 8 updates the claim detail data 15, based on the report data on the data transmission from the terminal 12 to the ledger recorder 14. Alternatively, the ledger recorder 14 transmits report data indicating that the data reception from the terminal 12 has been executed, to the electronic monetary claim system 8, and the electronic monetary claim system 8 updates the claim detail data 15, based on the report data on the data reception from the ledger recorder 14.

In the above-described present form, the electronically recorded monetary claim subject to condition precedent can be registered in the recording ledger data 16 after the initial time of ordering. Furthermore, in the present form, the claim detail data 15 which is the data more detailed than the recording ledger data 16 and which includes the state information from the initial time of generation to the present time, of the electronically recorded monetary claim subject to condition precedent, can be recorded apart from the recording ledger data 16, and the claim detail data 15 can be confirmed. Thus, system environment in which the electronically recorded monetary claim subject to condition precedent can easily be assigned after the initial time of generation can be provided and the electronically recorded monetary claim subject to condition precedent can be handled as the mortgage. In the present form, since the financial institution E2 can easily confirm the claim detail data 15 more detailed than the recording ledger data 16, for example, the financial institution E2 can determine whether to finance to the delivery company 2, easily and rapidly.

Additional advantages and modifications will readily occur to those skilled in the art. Therefore, the present disclosure in its broader aspects is not limited to the specific details and representative forms shown and described herein. Accordingly, various modifications may be made without departing from the spirit or scope of the general inventive concept as defined by the appended claims and their equivalents.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electronic monetary claim system communicably connected to a first terminal used by an order company, a second terminal used by a delivery company, a third terminal used by a financial institution of the delivery company, and a ledger recorder recording electronic record ledger data in an electronic monetary claim recording institution, the system comprising:
a first management unit transmitting generated record request data at receiving ordering, of an electronically recorded monetary claim with defense to the ledger recorder, by an electronic contract function, when receiving a placing order registration of the electronically recorded monetary claim with defense from receiving ordering to delivery and inspection from the first terminal and receiving a first approval registration of the placing order registration from the second terminal or when receiving a receiving order registration of the electronically recorded monetary claim with defense from the second terminal and receiving a second approval registration of the receiving order registration from the first terminal;
a second management unit transmitting assignment record request data including information indicating that the electronically recorded monetary claim with defense have been pledged to the ledger recorder as mortgage when an assignment request for pledging of the mortgage of the electronically recorded monetary claim is transmitted from the second terminal to the third terminal, then an approval corresponding to the assignment request is transmitted from the third terminal to the second terminal and, furthermore, when receiving a mortgage registration for pledging of the mortgage of the electronically recorded monetary claim with defense from the third terminal;
a third management unit recording, in a recorder, claim detail data indicating a detail of the electronically recorded monetary claim and including the first or second approval registration and the assignment request; and
a fourth management unit transmitting data included in the claim detail data recorded in the recorder to the third terminal, a fourth terminal used in a financial institution different from the financial institution or a fifth terminal used in a guarantee company,
wherein the claim detail data is data more detailed than the recording ledger data and includes a plurality of elements of history data from initial times of generation of a plurality of electronically recorded monetary claims with defense corresponding to the delivery company to a current time,
the plurality of the elements of the history data include information generated at the current time, of claim generation before delivery from the delivery company to the order company and inspection, assignment, extension or reduction of a payment period, change of a claim amount, termination of the condition precedent, and claim collection, for each of the plurality of the electronically recorded monetary claims with defense,
the second management unit transmits change record request data including information indicating the termination of the condition precedent of the electronically recorded monetary claim with defense to the ledger recorder, when receiving the termination of the condition precedent of the electronically recorded monetary claims with defense from any one of the first to third terminals,
the third management unit updates the claim detail data based on claim collection registration when the ledger recorder records payment of the electronically recorded monetary claim with defense and receives the claim collection record from the second terminal, and updates the claim detail data based on the termination of the condition precedent when receiving the termination of the condition precedent from any one of the first to third terminals, and
the fourth management unit transmits to the third terminal, the fourth terminal or the fifth terminal the plurality of the elements of the history data corresponding to the delivery company designated by the monitoring request received from the third terminal, the fourth terminal or the fifth terminal as data for determining an ability to fulfill an obligation of the delivery company designated by the monitoring request.

2. A method of managing pledge of mortgage of an electronically recorded monetary claim with defense by an electronic monetary claim system,
the electronic monetary claim system being communicably connected to a first terminal used by an order company, a second terminal used by a delivery company, a third terminal used by a financial institution of the delivery company, and a ledger recorder recording electronic record ledger data in an electronic monetary claim recording institution,
the electronic monetary claim system executing:
transmitting generated record request data at receiving ordering, of the electronically recorded monetary claim with defense to the ledger recorder, by an electronic contract function, when receiving a placing order registration of the electronically recorded monetary claim with defense from receiving ordering to delivery and inspection, from the first terminal, and receiving a first approval registration of the placing order registration from the second terminal or when receiving a receiving order registration of the electronically recorded monetary claim with defense from the second terminal and receiving a second approval registration of the receiving order registration from the first terminal;
transmitting assignment record request data including information indicating that the electronically recorded monetary claim have been pledged to the ledger recorder as mortgage when an assignment request for pledging of the mortgage of the electronically recorded monetary claim with defense is transmitted from the second terminal to the third terminal, then an approval corresponding to the assignment request is transmitted from the third terminal to the second terminal and, furthermore, when receiving a mortgage registration for pledging of the mortgage of the electronically recorded monetary claim with defense from the third terminal;
recording, in a recorder, claim detail data indicating a detail of the electronically recorded monetary claim with defense and including the first or second approval registration and the assignment request; and
transmitting data included in the claim detail data recorded in the recorder to the third terminal, a fourth terminal used in a financial institution different from the financial institution or a fifth terminal used in a guarantee company,
wherein the claim detail data is data more detailed than the recording ledger data and includes a plurality of elements of history data from initial times of generation of a plurality of electronically recorded monetary claims with defense corresponding to the delivery company to a current time,
the plurality of the elements of the history data include information generated at the current time, of claim generation before delivery from the delivery company to the order company and inspection, assignment, extension or reduction of a payment period, change of a claim amount, termination of the condition precedent, and claim collection, for each of the plurality of the electronically recorded monetary claims with defense, and
the electronic monetary claim system further executing:
transmitting change record request data including information indicating the termination of the condition precedent of the electronically recorded monetary claim with defense to the ledger recorder, when receiving the termination of the condition precedent of the electronically recorded monetary claims with defense from any one of the first to third terminals;
updating the claim detail data based on claim collection registration when the ledger recorder records payment of the electronically recorded monetary claim with defense and receives the claim collection record from the second terminal, and updates the claim detail data based on the termination of the condition precedent when receiving the termination of the condition precedent from any one of the first to third terminals; and
transmitting to the third terminal, the fourth terminal or the fifth terminal the plurality of the element of the history data corresponding to the delivery company designated by the monitoring request received from the third terminal, the fourth terminal or the fifth terminal as data for determining an ability to fulfill an obligation of the delivery company designated by the monitoring request.
